(19) United States
(12) Patent Application Publication
(10) Pub. No.: US 2018/0333935 A1
(43) Pub. Date: Nov. 22, 2018

(54) Solid-White Films for Pressure-Sensitive Labels

(71) Applicant: Jindal Films Americas LLC, LaGrange, GA (US)

(72) Inventor: Alain L. L. Marchal, Villers-le-Rond (FR)

(73) Assignee: Jindal Films Americas LLC, LaGrange, GA (US)

(21) Appl. No.: 16/039,458

(22) Filed: Jul. 19, 2018

Related U.S. Application Data
(63) Continuation of application No. PCT/US17/27027, filed on Apr. 11, 2017.
(60) Provisional application No. 62/321,041, filed on Apr. 11, 2016.

(51) Int. Cl. B32B 7/12; B32B 27/08; B32B 27/32

(52) U.S. Cl. CPC B32B 7/12; B32B 27/32; B32B 27/08

(57) ABSTRACT

Disclosed are methods, compositions, structures and uses for a biaxially oriented, multilayered film, including but not limited to a label, that may include a core layer comprising a cavitating agent, the core layer having a first side and a second side. Further, the film may include a first intermediate layer located on the first side and a second intermediate layer located on the second side, the first intermediate layer and the second intermediate layer comprising a pigmenting agent. Further still, the film may include a first skin layer located on the first intermediate layer and a second skin layer located on the second intermediate layers, wherein density is less than or equal to 0.85 g/cm³, whiteness is at least 84 using ASTM E 313, and each layer in the biaxially oriented, multilayered film may include polypropylene homopolymer.

### REFERENCE TO RELATED APPLICATION

This is a continuation, which claims priority to PCT application PCT/US17/27027 filed on Apr. 11, 2017, winch claims priority to U.S. application 62/321,041 filed Apr. 11, 2016, both of which are incorporated in their entireties.

### FIELD

This disclosure generally relates to substantially opaque white pressure-sensitive labels used in a wide variety of labeling applications.

### BACKGROUND

Manufacturers of films who wish to achieve an opaque, white appearance often utilize one of two well-known techniques. One technique consists of adding TiO₂ pigment to one or more layers of the film structure. Another technique consists of cavitating one or snore layers of the film with a cavitating agent such as polybutylene terephthalate (PBT) or calcium carbonate (CaCO₃).

Generally speaking, the cavitation method is cheaper and results in high opacity product having a lower density. However, this comes with a significant drawback as the presence of voids in one or more layers of the film leads to an increased tearing sensitivity on the Z-axis. The cavitated layer becomes a weak point that also results in increased visual distortion such as creasing and marking when squeezed.

Thus, customers may prefer to use a pigmented, or “Solid White” film utilizing the TiO₂ method. However, matching the opacity of a cavitated film requires substantial amounts of heavy and expensive pigment and the density of the film can be nearly double that of a cavitated film.

A need therefore exists for a well-balanced combination of cavitation and pigmentation which offers adequate fit-for-use (FFU) for pressure-sensitive labeling applications while retaining higher opacity, attractive yield, and profitability margins, while also maintaining the resistance to Z-tear propagation (film splitting).

### SUMMARY

Disclosed are ca vita ted. pigmented films that beneficially provide films having lower density than normally obtained with pigmented films (e.g., TiO₂ pigment) and also having higher opacity (i.e., lower light transmission) than normally obtained with cavitated films (e.g., through use PBT, CaCO₃, or other cavitating agents), which require comparatively less amount of pigmentation, which represents significant cost-savings and produces a lighter-weight film. Further, careful titration of the cavitating and pigmenting agents for a film has been found to attenuate Z-tear propagation and creasing problems sometimes associated with cavitated films. The white films producible from this disclosure may provide the foregoing benefits for films that may be further fashioned to have various mechanical properties and/or to meet FFU criteria, including, for example, for pressure-sensitive-labeling (PSL) applications.

### DRAWINGS

FIG. 1 depicts an illustrative diagram showing the balanced approach to high yield, high opacity, and low Z-tearing and/or creasing.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Various specific embodiments, versions and examples are now be described, including exemplary embodiments and definitions that are adopted herein for purposes of understanding. While the following detailed description gives specific preferred embodiments, those skilled in the art will appreciate that these embodiments are exemplary only, and that the disclosure can be practiced in other ways. For purposes of determining infringement, the scope of the invention will refer to the any claims, including their equivalents, and elements or limitations that are equivalent to those that are recited.

Disclosed are cavitated, pigmented films that beneficially provide films having lower density than normally obtained with pigmented films and also having higher opacity than normally obtained with cavitated films (e.g., through use of polymeric or mineral agents, such as PBT, glass beads, cyclic olefin polymers and/or cyclic olefin copolymers (“COC”), zeolites, CaCO₃, etc., and combinations thereof), all the while requiring comparatively less amount of pigmentation, which may be a significant cost-savings and produce a lighter-weight film.

Polymeric cavitating agent(s) may provide more uniform, spherical, and smaller particle sizes compared to fragments of mineral cavitating agents. As a result, this may lead to a more homogeneous voiding of the layer(s), and that may lead to a more efficient light harder and smaller sensitivity to Z-tear, i.e., layer splitting that may be initiated by large voids. Increased voiding homogeneity allows for more pushing of the cavitation of the layer(s) while keeping the PSL key properties at their requested level for FFU purposes. On the process side, the stretching conditions and stretching ratios are selected to prevent large voiding. Regarding the product structure, the respective composition and thickness ratio of the different layers are also selected in that respect.

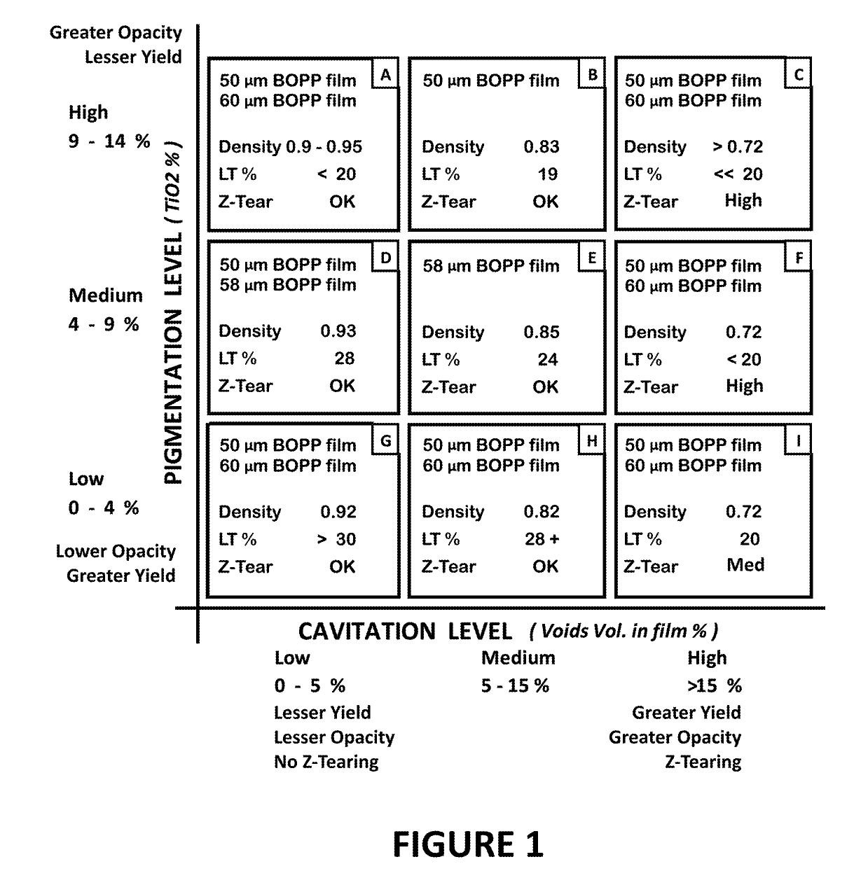

Turning now to FIG. 1, the developmental approach for example films supported by this disclosure is illustrated by suggested embodiments of useful cavitated, pigmented, multilayered polyolefin films. The cavitation level is located on the horizontal axis and is expressed in volume of air in the film, i.e., micrometers of air versus micrometers of film. Pigmentation level is located on the vertical axis and is expressed in percentage of titanium dioxide, TiO₂, pigment in the film. Equally, additional or alternative white pigments or other colored pigments may be used in other example embodiments, but for case of discussion, discussion continues herein with reference to TiO₂. Other factors also affect a film's appeal. For example, bending stiffness may be affected by a film's thickness, and may be nearly or completely independent of cavitation degree. Notably, film thickness, in both solid and cavitated films, routinely exceeds industry requirements tor FFU in label applications. So, a holistic approach to FFU films in PSL applications is necessary in order to cure under-developed and prevent over-developed structures.

Referring to FIG. 1, this figure illustrates that a balanced approach to high yield, high opacity, and low Z-tear/creasing is possible with 50-60 μm thick films, which offer adequate FFU solid white films for PSL applications with attractive yields of +10% versus an exclusively pigmented formulation. Analysis of each configuration, i.e., A-I, as denoted in the upper-right corner of each square, is depicted in order to help show support.

As an example, films were created using configurations D (medium pigmentation, high cavitation) and I (low pigmentation, high cavitation). Like all example films in FIG. 1, the coextruded structure comprises biaxially oriented polypropylene (“BOPP”). In other non-depicted example embodiments, the film's layers may additionally or alternatively include polyethylene, copolymers of ethylene and propylene, polyesters, and blends thereof, wherein polyethylene-based polymers should be slightly thicker, i.e., at least approximately 10 μm-30 μm thicker, than otherwise comparable polypropylene core equivalents in order to provide suitable stiffness for labeling applications.

With regard to film configuration D, the 50 μm and 58 μm embodiments' structures are shown in Tables 2 and 4. As shown in FIG. 1, film D has a density of 0.93 g/cm³, light transmission of 28% and an acceptable Z-tear, i.e., “OK.” An “OK” Z-tear means that the embodiments did not destructively split or crease under a tape test, and, therefore, these embodiments were sufficiently robust and acceptable under conventional industry standards for PSL applications. Configuration D is positioned in FIG. 1 because the combinations of layers in Configuration D have 4-9% pigmentation, i.e., a medium level, and 0-5% cavitation, i.e., a low level. Customers may prefer a great product yield, i.e., more square meters of film per kilogram of film, than configuration D offers because, understandably, customers want to spend less for a FFU film with sufficient white-opaqueness and integrity. Accordingly, FIG. 1 illustrates additional example film configurations also geared to this end.

With regard to film configuration I, having a film structure shown at Table 1, these highly cavitated and slightly pigmented films had a density of 0.72 g/cm³, light transmission of 20%, and a medium Z-tear based on analyses. As compared to film configuration D, film configuration I has a lower density because of increased cavitation, which decreases the film's Z-tear resistivity.

Branching out into other film configurations resulted in constructing and testing of film configurations B and E. With regard to film configuration E in FIG. 1, having a film structure as shown at Table 3, the density is 0.85 g/cm³, light transmission is 24%, and Z-tear is “OK.” Noticeably, as compared to previously discussed film configurations D and I, all three of these properties are strong. That is, film configuration E has a low density, which means more useable film for lower cost, a good light transmission rate that provides considerable white-opaqueness, and the film does not destructively split or crease.

Another embodiment of the invention in FIG. 1 is film configuration B. That is, the aim of film configuration B was to increase opacity as compared at least to film configuration E despite an 8 μm decrease in thickness. Here, film configuration B, having a film structure as shown at Table 5, has roughly the same density as film configuration E and passes the Z-tear test without destruction. However, opacity of film configuration B has markedly increased to a light transmission of 19%, principally because of increased pigmentation concentration in the cavitated, pigmented film.

Example configurations A, C, P, G, and H, as shown in FIG. 1, provide more example films having tweaked versions of the generalized multi-layered structures depicted in Tables 1-7, wherein the tweaking is to the cavitation and pigmentation concentrations necessary for their appropriate location on the graph in FIG. 1. Detailed structures are provided for configuration H in Table 6 and configuration F in Table 7. Configuration C was found not to be suitable due the overdesign for opacity resulting in unacceptably high Z-tearing, while configuration G was not fit for use due to low opacity levels due to inadequate pigmentation and cavitation levels.

As illustrated in the above discussion, a pattern emerges among the embodiments which are listed in FIG. 1. In general, as one moves from left to right on the X axis (greater cavitation), the yield of the film improves because density decreases, in the same direction, opacity increases but Z-tear deteriorates because cavitation increases. Adjusting pigmentation (the Y axis) in view of these patterns can supplement decreased cavitation to produce hybrids of cavitated, pigmented films that still providing sufficiently opaque-white films at a lower cost per square meter.

The following example Elms were produced, after cavitation, at a target of 58-60 μm and 50 μm. The film's resins were melted and combined in a die, such as T-die for coextending the film's layers, which were then cooled on a chili roll, and stretched to approximately 4.6 times in the machine direction (“MD”) and approximately 8.2 times in the transverse direction (“TD”) In other example BOPP embodiments, MD-stretching may occur within the range from approximately 4 to 6 times, and, more particularly, within the range from approximately 4.5 to 5.5 times, wherein the MD-stretching temperature may occur within the range from approximately 100 to 150° C., and, more particularly, within the range from approximately 110 to 125° C. Turning to another orientation direction, TD-stretching may occur within the range from approximately 6 to 10 times, and, more particularly, within the range from approximately 7.5 to 9 times, wherein the TD-stretching temperature may occur within the range from approximately 100 to 170° C., and, more particularly, within the range from approximately 140 to 160° C. For example structures that do not or only partially include BOPP compositions, then the ranges for amount of MD/TD stretching and stretching temperatures will differ as known in the art for different compositions.

TABLE 1
(Example 1, Configuration I in FIG. 1)

| | Resin Blend | Thickness |
|---|---|---|
| skin | Basell Adsyl 5C39F | 0.7 μm |
| layer | | |
| pigmented | 6% Ampacet AVK60 - pigment source | 3.5 μm |
| tie layer | 94% Total PPH4030S05 - BOPP | |
| core | 5% PBT BASF B2550FC - | 39.5 μm plain |
| layer | cavitating agent source | (51.6 μm cavitated) |
| | 75-95% Total PPH4030S05 - BOPP | |
| | 0-20% Reclaim White (i.e., | |
| | cavitated or non-cavitated | |
| | recycled film product(s)/scrap(s)) | |
| pigmented | 6% Ampacet AVK60 - pigment source | 3.5 μm |
| tie layer | 94% Total PPH4030S05 - BOPP | |
| skin | Basell Adsyl 5C39F | 0.7 μm |
| layer | | |

TABLE 2
(Example 2, Configuration D in FIG. 1)

| | Resin Blend | Thickness | |
|---|---|---|---|
| skin | Borealis TD210 BF | 0.9 | μm |
| layer | | | |
| pigmented | 9% Ampacet AVK70 or equivalent - | 3.3 | μm |
| tie layer | pigment source 91% Sabic PP521P - BOPP | | |
| core | 9.5% Ampacet AVK70 or equivalent - | 49.6 | μm |
| layer | pigment source | | |
| | 65.5% Sabic PP521P/524P - BOPP | | |
| | 25% Reclaim RESOLID (i.e., | | |
| | nothing cavitated in this | | |
| | recycled film product(s)/scrap(s)) | | |
| pigmented | 9% Ampacet AVK70 or equivalent - | 3.3 | μm |
| tie layer | pigment source 91% Sabic PP521P - BOPP | | |
| skin | Borealis TD210 BF | 0.9 | μm |
| layer | | | |

TABLE 3
(Example 3, Configuration E in FIG. 1)

| | Resin Blend | Thickness |
|---|---|---|
| skin | Borealis TD210 BF | 0.9 μm |
| layer | | |
| pigmented | 8% Ampacet AVK70 or equivalent - | 3.3 μm |
| tie layer | pigment source 92% Sabic PP521P - | |
| | BOPP | |
| core | 0.8% PBT BASF B2550FC - | 44 μm plain |
| layer | cavitating agent | (49.6 μm cavitated) |
| | 9.5% Ampacet AVK70 or equivalent - | |
| | pigment source | |
| | 64.7% Sabic PP521P/524P - BOPP | |
| | 25% Reclaim RESOLID | |
| pigmented | 8% Ampacet AVK70 or equivalent - | 3.3 μm |
| tie layer | pigment source 92% Sabic PP521P - | |
| | BOPP | |
| skin | Borealis TD210 BF | 0.9 μm |
| layer | | |

TABLE 4
(Example 4, Configuration D in FIG. 1)

| | Resin Blend | Thickness | |
|---|---|---|---|
| skin | Borealis TD210 BF | 0.9 | μm |
| layer | | | |
| pigmented | 11% Ampacet AVK70 or equivalent - | 2.9 | μm |
| tie layer | pigment source 89% Sabic PP521P - | | |
| | BOPP | | |
| core | 11% Ampacet AVK70 or equivalent - | 42.4 | μm |
| layer | pigment source 64% Sabic PP521P/524P - BOPP | | |
| | 25% Reclaim RESOLID | | |
| pigmented | 11% Ampacet AVK70 or equivalent - | 2.9 | μm |
| tie layer | pigment source 89% Sabic PP521P - | | |
| | BOPP | | |
| skin | Borealis TD210 BF | 0.9 | μm |
| layer | | | |

TABLE 5
(Example 5, Configuration B in FIG. 1)

| | Resin Blend | Thickness |
|---|---|---|
| skin | Borealis TD210 BF | 0.9 μm |
| layer | | |
| pigmented | 25% Ampacet AVK70 or equivalent - | 3.4 μm |
| tie layer | pigment source 75% Sabic PP521P - | |
| | BOPP | |
| core | 1.2% PBT BASF B2550FC - | 34.3 μm plain |
| layer | cavitating agent | (41.4 μm cavitated) |
| | 9.5% Ampacet AVK70 or equivalent - | |
| | pigment source | |
| | 64.3% Sabic PP521P/524P - BOPP | |
| | 25% Reclaim RESOLID | |
| pigmented | 25% Ampacet AVK70 or equivalent - | 3.4 μm |
| tie layer | pigment source 75% Sabic PP521P - | |
| | BOPP | |
| skin | Borealis TD210 BF | 0.9 μm |
| layer | | |

TABLE 6
(Example 6, Configuration H in FIG. 1)

| | Resin Blend | Thickness |
|---|---|---|
| skin | Borealis TD210 BF | 0.8 μm |
| layer | | |
| pigmented | 6% Ampacet AVK60 - | 3.4 μm |
| tie layer | pigment source 94% Total PPH4030S05 | |
| core | 3-5% PBT BASF B2550FC - | 45.4 μm plain |
| layer | cavitating agent | (51.6 μm cavitated) |
| | 77-95% Total PPH4030S05 | |
| | 0-20% Reclaim White | |
| pigmented | 6% Ampacet AVK60 - | 3.4 μm |
| tie layer | pigment source 94% Total PPH4030S05 | |
| skin | Borealis TD210 BF | 0.8 μm |
| layer | | |

TABLE 7
(Example 7, Configuration F in FIG. 1)

| | Resin Blend | Thickness |
|---|---|---|
| skin | Borealis TD210 BF | 0.8 μm |
| layer | | |
| pigmented | 9% Ampacet AVK70 or equivalent - | 3.4 μm |
| tie layer | pigment source 91% Sabic PP521P | |
| core | 5-7% PBT BASF B2550FC - | 38.9 μm plain |
| layer | cavitating agent | (51.6 μm cavitated) |
| | 75-93% Total PPH4030S05 | |
| | 0-20% Reclaim White | |
| pigmented | 9% Ampacet AVK70 or equivalent - | 3.4 μm |
| tie layer | pigment source 91% Sabic PP521P | |
| skin | Borealis TD210 BF | 0.8 μm |
| layer | | |

As previously mentioned, one possible white pigment for use is TiO₂, which may be sourced from a master batch. A possible cavitating agent is PBT, for instance, a medium viscosity grade of BASF B2550FC, CaCO₃ may be an additional or alternative cavitating agent. Ampacet AVK 60 and Ampacet AVK 70 are from masterbatches of 60% and 70%, respectively, of TiO₂ in polypropylene. Standard grades of a polypropylene homopolymer may be used in the core and/or tie layers. Terpolymer skins, e.g., Borealis TD210 or Basell Adsyl 5C39F ethylene-propylene-butylene terpolymer(s), may be used, but other polymers and/or copolymers may be used, including, for example, EP copolymers, LDPE, LLDPE, MDPE, HDPE, EVOH-based polymers, acrylic-based polymers, maleic anhydride-based polymers, elastomers, other polymers, and blends thereof. In Table 8, a summary of physical properties for film configurations B, D, E and I from FIG. 1 are provided.

TABLE 8

| | | (“~60 μm Films”) | | | (“50 μm Films”) | | |
|---|---|---|---|---|---|---|---|
| | | | | 58 μm | | | 50 μm |
| | | | | BOPP | | | BOPP High |
| | | 60 μm | 58 μm | High Yield | 50 μm | 50 μm | Opacity |
| | | BOPP | BOPP | (case D) | BOPP | BOPP | (case D) |
| Property Name | | (case I) | (case D) | Slightly | (case I) | (case D) | Slightly |
| Description | Units | Cavitated | Pure Solid | Cavitated | Cavitated | Pure Solid | Cavitated |
| Yield (ASTM D 4321) | m²/kg | 22.9 | 18.5 | 20.3 | 27.5 | 21.2 | 24.0 |
| Poly Gauge¹ | μm | 47.9 | 58 | 52.4 | 39.9 | 50 | 42.9 |
| Optical Gauge² | μm | 60 | 58 | 58 | 50 | 50 | 50 |
| Film Density³ | g/cm³ | 0.73 | 0.93 | 0.85 | 0.73 | 0.94 | 0.83 |
| Light Transmission | % | 20 | 28 | 24 | 22 | 29 | 18 |
| (ASTM D 1003) | | | | | | | |
| Volume of air | % | 20.2 | 0 | 9.6 | 20.2 | 0 | 14.3 |
| Whiteness Index | | 91.3 | 84.1 | 87.3 | 90 | 85.4 | 88.1 |
| (ASTM E 313) | | | | | | | |
| Gloss @ 45° (ASTM | % | 61 | 50.5 | 56.1 | 62 | 49.8 | 49 |
| D 2457) | | | | | | | |
| Color L⁴ | | 96.3 | 95.6 | 95.8 | 96.1 | 95.6 | 96.3 |
| Color a⁴ | | −0.5 | −1.2 | −0.9 | −0.5 | −1.15 | −0.8 |
| Color b⁴ | | −0.14 | 1.1 | 0.5 | −0.16 | 0.8 | 0.6 |
| MD Stiffness (L & W)⁵ | mN m | 26.5 | 26 | 27 | 16 | 18 | 16 |
| Norm DIN 53121 | | | | | | | |
| TD Stiffness (L & W)⁵ | mN m | 43.5 | 46.5 | 44 | 27 | 27.5 | 28 |
| Norm DIN 53121 | | | | | | | |
| MD E-modulus | MPa | 1600 | 2000 | 1800 | 1700 | 2300 | 1740 |
| (ASTM D 882) | | | | | | | |
| TD E-modulus (ASTM | MPa | 2600 | 4000 | 3200 | 2800 | 4150 | 3170 |
| D 882) | | | | | | | |
| Z-Tear - mode | (*) | Core | Tape | Tape | Core | Tape | Tape peeling |
| | | splitting | peeling | peeling | splitting | peeling | |
| Z-Tear propagation | g/25.4 mm | 636 | NA | NA | 620 | NA | NA |
| Creasing level | | Medium | None | None | Medium | None | Very slight |

(*) - The Z-tear testing quantifies sensitivity to core splitting, wherein the core layer is the weakest layer because of the cavitation. The recorded force represents the tear propagation only when breakage of the film occurs. If not broken, then a recorded value is meaningless because destruction did not occur.
¹Calculation is based on the measured yield and the density of the processed materials.
²Calculation uses mechanical micrometer and Mahr tester.
³Calculation is based on measured yield and measured optical gauge, i.e., density = (1/yield) * (1000) * (1/Optical Gauge)
⁴Color values are based on the colorimeiry scale; L = black/white, a = red/green, b = blue/yellow
⁵Equipment used is Lorentzen & Wettre Bending Resistance Tester

The objective of the Z-Tear test is to measure the force required to split the film in the z-axis, i.e., through its thickness. A controlled test allows for reproducible results. Measurements are made by using a load cell, adhesive tape, and the film sample. Adhesive tape is attached to the load cell and pulled perpendicularly from and relative to the surface of the film sample. Force is recorded as the film is separated from the z-axis. The interfacial adhesion is then reported as an average value, in g/25.4 mm, as the tape is pulled.

As used herein, “polymer” may be used to refer to homopolymers, copolymers, interpolymers, terpolymers, etc. Likewise, a “copolymer” may refer to a polymer comprising two monomers or to a polymer comprising three or more monomers.

As used herein, “intermediate” is defined as the position of one layer of a multilayered film wherein said layer lies between two other identified layers. In some embodiments, the intermediate layer may be in direct contact with either or both of the two identified layers. In other embodiments, additional layers may also be present between the intermediate layer and either or both of the two identified layers.

As used herein, “elastomer” is defined as a propylene-based or ethylene-based copolymer that can be extended or stretched with force to at least 100% of its original length, and upon removal of the force, rapidly (e.g., within 5 seconds) returns to its original dimensions.

As used herein, “substantially free” is defined to mean that the referenced film layer is largely, but not wholly, absent a particular component. In some embodiments, small amounts of the component may be present within the referenced layer as a result of standard manufacturing methods, including recycling of film scraps and edge trim during processing.

### Core Layer

As is known to those skilled in the art, the core layer of a multilayered film is most commonly the thickest layer and provides the foundation of the multilayered structure. In some embodiments, the core layer includes PP. In alternate embodiments, the core may also contain lesser amounts of additional polymer(s) selected from the group consisting of propylene polymer, ethylene polymer, ethylene-propylene copolymers, ethylene-propylene-butene terpolymers, elastomers, plastomers, and combinations thereof. Although not limiting in any way, two examples of suitable LLDPE were: (1) one with a melting index of 1 to 3 g/10 min (measured at 190° C.-2.13 Kg conditions), a density of 0.915 to 0.930 g/cm³, and a melting peak of 115 to 135° C.

In addition to the foregoing, the com layer may further comprise one or more additional additives such as opacifying agents, colorants, slip agents, antioxidants, anti-fog agents, anti-static agents, fillers, moisture barrier additives, gas barrier additives, and combinations thereof, as discussed in further detail below. A suitable anti-static agent is ARMOSTAT™ 475 (commercially available from Akzo Nobel of Chicago, Ill.).

Cavitating agents may be present in the core layer in an amount less than 30 wt %, preferably less than 20 wt %. most preferably in the range of from 2 wt % to 10 wt %, based on the total weight of the core layer.

Preferably, the total amount of additives in the com layer comprises up to about 20 wt % of the core layer, but some embodiments may comprise additives in the core layer in an amount up to about 30 wt % of the core layer.

The core layer preferably has a thickness in the range of from about 5 μm to 100 μm, more preferably from about 20 μm to 100 μm, most preferably from 30 μm to 70 μm.

### Tie Layer(s)

Tie layer(s) of a multilayered film is typically used to connect two other layers of the multilayered film structure, e.g., a core layer and a sealant layer, and is positioned intermediate these other layers. The tie layer(s) may have the same or a different composition as compared to the core layer.

In some embodiments, the tie layer is in direct contact with the surface of the core layer. In other embodiments, another layer or layers may be intermediate the core layer and the tie layer. The tie layer may comprise one or more polymers. In addition, the polymers may include C₂ polymers, C₃ polymers, C₂C₃ random copolymers, C₂C₃C₄ random terpolymers, heterophasic random copolymers, C₄ homopolymers, C₄ copolymers, metallocene polymers, propylene-based or ethylene-based elastomers and/or plastomers, or combinations thereof.

In some embodiments, the tie layer may further comprise one or more additives such as opacifying agents, pigments, colorants, cavitating agents, slip agents, antioxidants, anti-fog agents, anti-static agents, anti-block agents, fillers, moisture barrier additives, gas barrier additives, and combinations thereof, as discussed in further detail below.

The thickness of the tie layer is typically in the range of from about 0.50 to 25 μm, preferably from about 0.50 μm to 12 μm, more preferably from about 0.50 μm to 6 μm, and most preferably from about 2.5 to 5 μm. However, in some thinner films, the tie layer thickness may be from about 0.5 μm to 4 μm, or from about 0.5 μm to 2 μm, or from about 0.5 μm to 1.5 μm.

A skin layer is optional, and, when present, is provided on the outer surface(s) surface of the tie layer(s) or core layer. Skin layer(s) may be provided to improve the film's barrier properties, processability, printability, and/or compatibility for metallization, coating, and/or lamination to other films or substrates.

In some embodiments, the skin layer comprises at least one polymer selected from the group consisting of a polyethylene polymer or copolymer, a polypropylene polymer or copolymer, an ethylene-propylene copolymer, an ethylene-propylene-butene (“EPB”) terpolymer, a propylene-butene copolymer, an ethylene-vinyl alcohol polymer, and combinations thereof. Preferably, the polyethylene polymer is LLDPE such as Exceed™ resin from ExxonMobil Chemicals or Evolute™ resin from Prime Polymer or Elite™ resin from Dow. A suitable ethylene-propylene copolymer is Fina 8573 (commercially available from Fina Oil Company of Dallas, Tex.). A suitable EPB terpolymer is Chisso 7510 and 7794 (commercially available from Chisso Corporation of Japan). For coating and printing functions, the skin layer may preferably be surface-treated. For metallizing or barrier properties, the skin layer may contain LLDPE or ethylene vinyl alcohol based polymer(s) (“EVOH”). Suitable EVOH copolymer is EVAL™ G176B or XFP 1300 (commercially available from Kurarav Company Ltd. of Japan).

The skin layer may also comprise processing aid additives, such as anti-block agents, anti-static agents, slip agents and combinations thereof, as discussed in further detail below.

The thickness of the skin layer depends upon the intended function of the skin layer, but is typically in the range of from about 0.50 μm to 3.5 μm, preferably from about 0.50 μm to 2 μm, and in many embodiments most preferably from about 0.50 μm to 1.5 μm. Also, in thinner film embodiments, the skin layer thickness may range from about 0.50 μm to 1.0 μm, or 0.50 μm to 0.75 μm.

### Coating

In some embodiments, one or more coatings, such as for barrier, printing and/or processing, may be applied to outer surface(s) of the multilayered films. For instance, the coating(s) may be directly on the outer surfaces (i.e., those surfaces facing away from the core) of tie layers, on either or both sides of the core layer, or elsewhere. Such coatings may include acrylic polymers, such as ethylene acrylic acid (EAA), ethylene methyl acrylate copolymers (EMA), polyvinylidene chloride (PVdC), poly(vinyl)alcohol (PVOH) and EVOH. The coatings may be applied by an emulsion or solution coating technique or by co-extrusion and/or lamination.

The PVdC coatings that may be suitable for use with the multilayered films are any of the known PVdC compositions heretofore employed as coatings in film manufacturing operations, e.g., any of the PVdC materials described in U.S. Pat. No. 4,214,039, U.S. Pat. No. 4,447,494, U.S. Pat. No. 4,961,992, U.S. Pat. No. 5,019,447, and U.S. Pat. No. 5,057,177, incorporated herein by reference.

Known vinyl alcohol-based coatings, such as PVOH and EVOH, that are suitable for use with the multilayered films include VINOL™ 125 or VINOL™ 325 (both commercially available from Air Products, Inc. of Allentown, Pa.). Other PVOH coatings are described in U.S. Pat. No. 5,230,963, incorporated herein by reference.

Before applying the coating composition to the appropriate substrate, the outer surface(s) of the film may be treated as noted herein to increase its surface energy. This treatment can be accomplished by employing known techniques, such as flame treatment, plasma, corona discharge, film chlorination, e.g., exposure of the film surface to gaseous chlorine, treatment with oxidizing agents such as chromic acid, hot air or steam treatment, flame treatment and the like. Although any of these techniques is effectively employed to pre-treat the film surface, a frequently preferred method is corona discharge, an electronic treatment method that includes exposing the film surface to a high voltage corona discharge while passing the Elm between a pair of spaced electrodes. After treatment of the film surface, the coating composition is then applied thereto.

Coating compositions may be applied to the film as a water-based solution. The coating composition may be applied to the treated surface in any convenient manner, such as by gravure coating, roll coating, dipping, spraying, and the like. The excess aqueous solution can be removed by squeeze rolls, doctor knives, and the like.

In some embodiments, an adhesive is placed on the film's exterior surface opposite the other exterior surface, which optionally has a coating, such as for barrier, printing and/or processing. In such example embodiments, the adhesive side may have a releasable liner, such as for labeling applications.

### Additives

Additives that may be present in one or more layers of the multilayered films, include, but are not limited to opacifying agents, pigments, colorants, cavitating agents, slip agents, antioxidants, anti-fog agents, anti-static agents, anti-block agents, fillers, moisture barrier additives, gas barrier additives and combinations thereof. Such additives may be used in effective amounts, which vary depending upon the property required. Additives such as oxygen scavenger or gas scavenger can be added in any layer.

Slip agents may include higher aliphatic acid amides, higher aliphatic acid esters, waxes, silicone oils, and metal soaps. Such slip agents may be used in amounts ranging from 0.1 wt % to 2 wt % based on the total weight of the layer to which it is added. An example of a slip additive that may be useful is high molecular PDSM (poly dimethyl siloxane) silicone gum.

Non-migratory slip agents, used in one or more skin layers of the multilayered films, may include polymethyl methacrylate (PMMA). The non-migratory slip agent may have a mean particle size in the range of from about 0.5 μm to 8 μm, or 1 μm to 5 μm, or 2 μm to 4 μm, depending upon layer thickness and desired slip properties. Alternatively, the size of the particles in the non-migratory slip agent, such as PMMA, may be greater than 20% of the thickness of the skin layer containing the slip agent, or greater than 40% of the thickness of the skin layer, or greater than 50% of the thickness of the skin layer. The size of the particles of such non-migratory slip agent may also be at least 10% greater than the thickness of the skin layer, or at least 20% greater than the thickness of the skin layer, or at least 40% greater than the thickness of the skin layer. Generally spherical, particulate non-migratory slip agents are contemplated, including PMMA resins, such as EPOSTAE™ (commercially available from Nippon Shokubai Co., Ltd. of Japan). Other commercial sources of suitable materials are also known to exist. Non-migratory means that these particulates do not generally change location throughout the layers of the film in the manner of the migratory slip agents. A conventional polydialkyl siloxane, such as silicone oil or gum additive having a viscosity of 10,000 to 2,000,000 centistokes is also contemplated.

Suitable anti-oxidants may include phenolic anti-oxidants, such as IRGANOX® 1010 (commercially available from Ciba-Geigy Company of Switzerland), Such an anti-oxidant is generally used in amounts ranging from 0.1 wt % to 2 wt %, based on the total weight of the layer(s) to which it is added.

Anti-static agents may include alkali metal sulfonates, polyether-modified polydiorganosiloxanes, polyalkylphenylsiloxanes, and tertiary amines. Such anti-static agents may be used in amounts ranging from about 0.05 wt % to 3 wt %, based upon the total weight of the layer(s).

Examples of suitable anti-blocking agents may include silica-based products such as SYLOBLOC® 44 (commercially available from Grace Davison Products of Colombia, Md.), PMMA particles such as EPOSTAR™ (commercially available from Nippon Shokubai Co., Ltd. of Japan), or polysiloxanes such as TOSPEARL™ (commercially available from GE Bayer Silicones of Wilton, Conn.). Such an anti-blocking agent comprises an effective amount up to about 3000 ppm of the weight of the layer(s) to which it is added.

Useful fillers may include finely divided inorganic solid materials such as silica, fumed silica, diatomaceous earth, calcium carbonate, calcium silicate, aluminum silicate, kaolin, talc, bentonite, clay and pulp.

Suitable moisture and gas barrier additives may include effective amounts of low-molecular weight resins, hydrocarbon resins, particularly petroleum resins, styrene resins, cyclopentadiene resins, and terpene resins.

Optionally, one or more skin layers may be coated with a wax-containing coating, for lubricity, in amounts ranging from 2 wt % to 15 wt % based on the total weight of the skin layer. Any conventional wax, such as, but not limited to Carnauba™ wax (commercially available from Michelman Corporation of Cincinnati, Ohio) that is useful in thermoplastic films is contemplated.

### Orientation

The embodiments include possible uniaxial or biaxial orientation of the multilayered films. Orientation in the direction of extrusion is known as machine direction (MD) orientation. Orientation perpendicular to the direction of extrusion is known as transverse direction (TD) orientation. Orientation may be accomplished by stretching or pulling a film first in the MD followed by TD orientation. Blown films or cast films may also be oriented by a tenter-frame orientation subsequent to the film extrusion process, again in one or both directions. Orientation may be sequential or simultaneous, depending upon the desired film features. Preferred orientation ratios are commonly from between about three to about six times the extruded width in the machine direction and between about four to about fen times the extruded width in the transverse direction. Typical commercial orientation processes are BOPP tenter process, blown film, and LISIM technology.

### Surface Treatment

One or both of the outer surfaces of the multilayered films, and, in particular, the sealant layers, may be surface-treated to increase the surface energy to render the film receptive to metallization, coatings, printing inks, and/or lamination. The surface treatment can be carried out according to one of the methods known in the art including corona discharge, flame, plasma, chemical treatment, or treatment by means of a polarized flame.

### Metallization

Outer surface(s) (i.e., the side facing away from the core) of the multilayered films may be metallized and optionally coated thereafter. For example, outer surfaces of the sealant layers and/or skin layers may undergo metallization after optionally being treated. Metallization may be carried out through conventional methods, such as vacuum metallization by deposition of a metal layer such as aluminum, copper, gold, silver, zinc, chromium, or mixtures thereof, or any other metallization technique, such as electroplating or sputtering. Typically, a metal layer is applied to an optical density (OD) of from 1.5 to 5.0 or preferably from 1.8 to 4.0, in accordance with the standard procedure of ANSI/NAPM IT2.19.

In certain embodiments, the metal is metal oxide, any other inorganic materials, or organically modified inorganic materials, which are capable of being vacuum deposited, electroplated or sputtered, such as, for example, SiOₓ, AlOₓ, SnOₓ, ZnOₓ, IrOₓ, organically modified ceramics “ormocer”, etc. Here an integer x is 1 or 2. The thickness of the deposited layer is typically in the range from 100 to 5,000 Å or preferably from 300 to 3000 Å.

### Priming

An primer coating may be applied to any surface of the multilayered films. In this case, the film may be first treated by one of the foregoing methods to provide increased active adhesive sites thereon and to the thus-treated film surface there may be subsequently applied a continuous coating of a primer material. Such primer materials are well known in the art and include, for example, epoxy and poly(ethylene imine) (PEI) materials. U.S. Pat. No. 3,753,769, U.S. Pat. No. 4,058,645 and U.S. Pat. No. 4,439,493, each incorporated herein by reference, disclose the use and application of such primers. The primer provides an overall adhesively active surface for thorough and secure bonding with the subsequently applied coating composition and can be applied to the film by conventional solution coating means, for example, by roller application.

The films herein are also characterized in certain embodiments as being biaxially oriented, such as by the procedure described in U.S. Pat. No. 8,080,294, incorporated herein by this reference. The films may be made by any suitable technique known in the art, such as a tenter process, double bubble process, LISIM™, or others. Further, the working conditions, temperature settings, lines speeds, etc. will vary depending on the type and the size of the equipment used. Nonetheless, described generally here is one method of making the films described throughout this disclosure. In one particular embodiment, the films are formed and biaxially oriented using the “tentered” method. In the tenter process, sheets/films of the various materials are melt-blended and coextruded, such as through a 3, 4, 5, 7-layer die head, into the desired film structure. Extruders may be used to melt-blend the molten layer materials, the melt streams then metered to the die. The extruded sheet is then cooled using air, water, or both.

Downstream of the first cooling step in this example embodiment of the tentered process, the unoriented sheet is re-heated to a temperature of from 60 to 100 or 120 or 150° C. by any suitable means, such as heated S-wrap rolls, and then passed between closely spaced differential speed rolls to achieve machine-direction orientation. It is understood by those skilled in the art that this temperature range may vary depending upon the equipment, and, in particular, upon the identity and composition of the components constituting the film. Ideally, the temperature will be below that which will melt the film, or cause it to become tacky and adhere to the equipment, but high enough to facilitate the machine-direction orientation process. Notably, such temperatures referred to herein refer to the film temperature, itself. The film temperature may be measured by using, for example, infrared spectroscopy, the source being aimed at the film as it is being processed; those skilled in the art will understand that measuring the actual film temperature may not be precise and/or fully accurate. In this case, those skilled in the art may estimate the temperature of the film by knowing the temperature of the air or roller immediately adjacent to the film that is measured by any suitable means. The heating means for the film line may be set at any appropriate level of heating, depending upon the instrument, to achieve the stated or desired film temperatures.

Subsequently, the lengthened and thinned film is cooled and passed to the tenter section of the line for TD orientation. At this point, the edges of the sheet are grasped by mechanical clips on continuous chains and pulled into a long, precisely controlled, hot-air oven for a pre-heating step. The film temperatures may range from 80 or 110 to 150 or 160° C. in the pre-heating step. Again, the temperature is ideally below that which will melt the film, but high enough to facilitate the step of transverse-direction orientation. Next, the edges of the sheet are grasped by mechanical clips on continuous chains and pulled into a long, precisely controlled, hot-air oven for transverse stretching. The tenter chains diverge a desired amount to stretch the film in the transverse direction at a temperature high enough to facilitate the step of transverse-direction orientation but low enough so as not to melt the film. After stretching to the required transverse orientation, the film is then cooled from 5 to 10 or 15 or 20 or 30 or 40° C. below the stretching temperature, and the mechanical clips are released prior to any edge trimming. Thereafter, optional corona or any other treatment may take place followed by winding.

Thus, in certain embodiments the film(s) described herein are biaxially oriented with at least a 5 or 6 or 7 or 8-fold TD orientation and at least a 2 or 3 or 4-fold MD orientation.

The prepared multilayered films may be used in PSL applications on packages or other substrates that package articles or goods or serve as a printable surface for labeling products. While the foregoing is directed to example embodiments of the disclosed invention, other and further embodiments may be devised without departing from the basic scope thereof, wherein the scope of the disclosed apparatuses, systems and methods are determined by one or more claims.

What is claimed is:

1. A biaxially oriented, multilayered film comprising:
a core layer comprising polypropylene homopolymer and a cavitating agent, the core layer having a first side and a second side;
a first tie layer located on the first side and a second tie layer located on the second side, the first tie layer and the second tie layer comprising polypropylene homopolymer and pigment(s); and
a first skin layer located on the first tie layer and a second skin layer located on the second tie layer, the first skin layer and the second skin layer comprising ethylene-butylene polymer,
wherein density of the biaxially oriented, multilayered film is less than or equal to 0.85 g/cm3 and whiteness is at least 84 using ASTM E 313.

2. The biaxially oriented, multilayered film of claim 1, wherein the cavitating agent comprises up to 5 wt % of the core layer.

3. The biaxially oriented, multilayered film of claim 1, wherein the pigment(s) comprises up to 25 wt % of the first tie layer, the second tie layer or both.

4. The biaxially oriented, multilayered film of claim 1, wherein the core further comprises up through 25 wt. % reclaimed biaxially oriented, multilayered film.

5. The biaxially oriented, multilayered film of claim 1, wherein the core layer further comprises polyethylene.

6. The biaxially oriented, multilayered film of claim 4, wherein the biaxially oriented, multilayered film has a total thickness between 50 and 60 μm.

7. The biaxially oriented, multilayered film of claim 5, wherein the biaxially oriented, multilayered film has a total thickness between 60 and 90 μm.

8. The biaxially oriented, multilayered film of claim 1, wherein the core layer further comprises one or more additives.

9. The biaxially oriented, multilayered film of claim 1, wherein the core layer further comprises pigment(s).

10. The biaxially oriented, multilayered film of claim 1, wherein Z-tear propagation is at least 620 g/25.4 mm when thickness of the biaxially oriented, multilayered film is within a range from 50 through 60 μm.

11. The biaxially oriented, multilayered film of claim 1, wherein the biaxially oriented, polypropylene, multilayered film has a light transmission of less than 30%.

12. The biaxially oriented, multilayered film of claim 1, wherein stiffness is at least 15 mN-m in a machine direction.

13. The biaxially oriented, multilayered film of claim 1, wherein stiffness is at least 25 mN-m in a transverse direction.

14. The biaxially oriented, multilayered film of claim 1, wherein at least one of the first skin layer and the second skin layer is subjected to corona discharge treatment, flame treatment, polarized flame treatment, plasma treatment, chemical treatment, or combinations thereof.

15. The biaxially oriented, multilayered film of claim 1, wherein at least one of the first skin layer and the second skin layer is metallized.

16. The biaxially oriented, multilayered film of claim 1, wherein the biaxially oriented, multilayered film has a gloss of at least 40% at 45°.

17. The biaxially oriented, multilayered film of claim 1, wherein the biaxially oriented, multilayered film has a volume of air of at least 10%.

18. The biaxially oriented, multilayered film of claim 1, wherein the biaxially oriented, multilayered film has a yield of at least 10% more if not cavitated.

19. The biaxially oriented, multilayered film of claim 1, wherein elastic modulus is less than 2 GPa in a machine direction.

20. The biaxially oriented, multilayered film of claim 1, wherein the biaxially oriented, multilayered film is a pressure-sensitive label.
